(19) United States
(12) Patent Application Publication
(10) Pub. No.: US 2009/0020134 A1
(43) Pub. Date: Jan. 22, 2009

(54) Apparatus and method for holding and manipulating dental floss

(76) Inventors: Corey Tomsic, Artesia, NM (US); Tammy Tomsic, Artesia, NM (US)

Correspondence Address: Russ Weinzimmer, 614 Nashua St. #204, Milford, NH, 03055, US

(21) Appl. No.: 11/879,672

(22) Filed: Jul. 18, 2007

(51) Int. Cl. A61C 15/04

(52) U.S. Cl. 132/327

(57) ABSTRACT

An apparatus and method are disclosed for firmly and comfortably holding and manipulating dental floss without obstructing blood flow in the fingers. The apparatus provides a high degree of dexterity and tactile control, thereby allowing the dental floss to be easily positioned anywhere within the mouth, and allowing the positioning to be readily guided by touch. The apparatus includes a pair of elastomeric sleeves, each worn on a user's finger. A length of dental floss is tensioned between the sleeves by wrapping each end of the dental floss around a sleeve (each end also preferably being glued to a sleeve) and then separating the sleeves until the floss is pulled tightly between them. The sleeves are then inserted into the mouth so as to pass the floss between the teeth. In preferred embodiments, texturing is provided on each sleeve to inhibit slippage of the dental floss on the sleeve.

### FIELD OF THE INVENTION

The invention relates to oral hygiene, and more particularly to using dental floss more effectively and comfortably.

### BACKGROUND OF THE INVENTION

A typical regimen of oral hygiene includes cleaning easily accessible surfaces of the teeth using a toothbrush and toothpaste, and cleaning the spaces between the teeth with dental floss. A complete program of oral hygiene should include cleaning and stimulation of all of the teeth and gums, including those hard-to-reach surfaces between the teeth, such as those far back in the mouth.

A toothbrush is easy to use for reaching all of the more accessible tooth surfaces. Dental floss, however, can be difficult to hold with enough firmness to maintain a grip while inserting it between the teeth, and then rubbing it against the sides of the teeth. Furthermore, if the floss is held with sufficient firmness to maintain the needed grip, it can press so tightly against one's fingers that it becomes uncomfortable, and can even cut into the flesh and/or interfere with circulation, leaving visible and uncomfortable indentations. If the floss is not held firmly, it will slip between the fingers, and either will not go where it's needed, or will remain stuck between the teeth. These difficulties commonly cause individuals who brush regularly to nevertheless neglect flossing, despite the importance of flossing to oral hygiene.

Several devices intended to make flossing easier and more comfortable to use are known. Some of these devices capture the floss tightly in an essentially rigid section attached to a handle. Such devices cannot be used with the same degree of dexterity that is possible when dental floss is hand-held, and they severely reduce one's ability to use the sense of touch for guiding the dental floss within the mouth. The use of touch to guide dental floss is important due to the relatively inaccessible areas that the floss must reach, and the difficulty of seeing clearly into the mouth, even with the help of a mirror.

Other proposed devices for holding and manipulating dental floss are used by being attached to a finger or a hand, thereby providing for a level of dexterity that is better than a rigid floss holder, but provide considerably less control over the floss then when dental floss is hand-held. These devices also interfere with one's ability to guide the dental floss within the mouth by feel, and they are time consuming and cumbersome to attach and remove. In addition, these devices are too complex and expensive to be treated as disposable, and hence must be thoroughly cleaned after each usage.

### SUMMARY OF THE INVENTION

An apparatus for holding and manipulating dental floss is disclosed, together with a method for the usage thereof, that is sufficiently inexpensive to allow it to be treated as disposable, that enables a user to grip dental floss firmly, easily, and comfortably, while maintaining the dexterity associated with hand-held flossing. In preferred embodiments, the invention also provides for cleaning and stimulating of all the surfaces within the mouth, including those surfaces of the teeth normally cleaned by use of a toothbrush, and those tissue surfaces within the mouth that are well removed from the teeth.

The apparatus includes a pair of elastic sleeves that fit over two of a user's fingers, typically but not necessarily the index finger of each hand. During use, dental floss is attached to the sleeves by wrapping each end of a length of floss one or more times around each of the sleeves and then separating the fingers in such a way that the floss extending between the sleeves is pulled tight. The sleeves are each of a thickness sufficient to prevent tightly wrapped dental floss from causing discomfort or interference with circulation, and are of a size, elasticity, and inner surface friction sufficient to cause them to be held firmly in place on the fingers while worn.

By inserting the sleeve-covered fingers into the mouth while holding the dental floss between them as described above, the dental floss can be easily inserted into all the inter-tooth spaces, and the spaces between the teeth can be cleaned thereby in essentially the same manner as if the floss were hand-held.

In a preferred embodiment, one end of the floss is glued to one of the sleeves, and the other end of the floss is glued to the other sleeve. In another preferred embodiment, the floss is temporarily attached to the sleeves by causing the ends of the floss to be overlapped by the floss wrapped around the sleeves.

In preferred embodiments, the sleeves are sufficiently flexible and thin to allow them to be rolled up when not in use, thereby providing for easier packaging and storage, protection of the surfaces from exposure to contaminants, and easy installation and removal by placing each sleeve against the tip of a finger and unrolling it onto the finger, and then after use removing each sleeve by unrolling it from the finger.

In a further preferred embodiment, the sleeves include areas on their surfaces that include grooves, or regions roughened to a degree and in a manner that will inhibit the dental floss from tending to slide along the surface of the sleeves while in use.

In other preferred embodiments, at least one sleeve includes one or more regions with textures and degrees of firmness suitable for cleaning teeth and/or for cleaning and stimulating gums and other tissue surfaces within the mouth. By installing the at least one sleeve of these preferred embodiments on a finger and rubbing the suitable region or regions of the sleeve against the appropriate surfaces within the mouth, areas of the mouth that are not cleaned by dental floss can be cleaned directly by the sleeve.

Accordingly, one general aspect of the invention is an apparatus for enhanced dental flossing. The apparatus includes a pair of elastomeric sleeves, each sized so as to be in a expanded condition when worn on a finger, each sleeve having an inner surface capable of substantially resisting slippage of the sleeve on the finger, and having an outer surface capable of substantially resisting slippage of the dental floss across the outer surface of the sleeve.

In preferred embodiments, each elastomeric sleeve of the pair is made from latex.

In other preferred embodiments, each elastomeric sleeve of the pair is made of an elastomeric material that is of a thickness such that each finger is substantially protected from discomfort, even when the floss is wrapped tightly around each elastomeric sleeve, and then pulled between teeth.

In further embodiments, the apparatus also includes a length of dental floss having a first end and a second end, the first end being glued to the first elastomeric sleeve, and the second end being glued to the second elastomeric sleeve.

In some preferred embodiments, each elastomeric sleeve includes a portion bearing surface texturing capable of more surely gripping the floss than a smooth portion of the elastomeric sleeve. In further preferred embodiments, the portion bearing surface texturing includes a surface bearing grooves capable of impeding slippage of dental floss over the surface when the floss is under tension during use. In alternate further embodiments, the portion bearing surface texturing includes a surface bearing bumps capable of impeding slippage of dental floss over the surface when the floss is under tension during use.

In preferred embodiments, the pair of elastomeric sleeves are stored in a rolled-up condition, such that they each can be placed on the tip of a finger, and then rolled down upon the finger for use.

In some preferred embodiments, the pair of elastomeric sleeves each includes a curled end for assisting in removing each sleeve by unrolling it from the finger.

In many preferred embodiments, the pair of sleeves is disposable.

In yet more preferred embodiments, at least a portion of the outer surface of at least one sleeve bears a texture capable of cleaning and stimulating at least gums within the mouth. In other preferred embodiments, at least a portion of the outer surface of at least one sleeve bears a surface that is capable of gently massaging sensitive tissue in a mouth.

Another general aspect of the invention is a method for using dental floss. The method includes: rolling a first elastomeric sleeve onto a first finger, rolling a second elastomeric sleeve onto a second finger, wrapping a first end of a length of dental floss at least one full turn around the first elastomeric sleeve; wrapping the second end of the length of dental floss at least one full turn around the second elastomeric sleeve; applying tension to the length of dental floss so as to cause the first end of the length of dental floss to be held tightly in place around the first elastomeric sleeve, and the second end to be held tightly in place around the second elastomeric sleeve; and repeatedly passing the dental floss between and over a surface of teeth in a mouth.

In further preferred embodiments, the method also includes stimulating gums using at least a portion of at least one sleeve bearing a texture capable of gum stimulation.

Another general aspect of the invention is an apparatus for enhanced dental flossing, such that the apparatus includes: a pair of elastomeric sleeves, each sleeve sized so as to be in a expanded condition when worn on a finger, each sleeve having an inner surface capable of substantially resisting slippage of the sleeve on the finger, each sleeve having an outer surface capable of substantially resisting slippage of the dental floss across the outer surface of the sleeve, each sleeve being make from a material of a thickness such that each finger is substantially protected from discomfort, even when the floss is wrapped tightly around each sleeve, and then pulled between teeth, each sleeve including a portion bearing surface texturing capable of more surely gripping the floss than a smooth portion of the sleeve; and a length of dental floss having a first end and a second end, the first end being glued to the first sleeve, and the second end being glued to the second sleeve.

In preferred embodiments, each elastomeric sleeve is made from latex.

In some preferred embodiments, the portion bearing surface texturing includes a surface bearing grooves capable of impeding slippage of dental floss over the surface when the floss is under tension during use.

In other preferred embodiments, the portion bearing surface texturing includes a surface bearing bumps capable of impeding slippage of dental floss over the surface when the floss is under tension during use.

In still other preferred embodiments, the pair of sleeves are stored in a rolled-up condition, such that they each can be placed on the tip of a finger, and then rolled down upon the finger for use.

In more preferred embodiments, at least a portion of the outer surface of at least one sleeve bears a texture capable of cleaning and stimulating at least gums within the mouth.

### BRIEF DESCRIPTION OF THE DRAWINGS

The invention will be more fully understood by reference to the detailed description, in conjunction with the following figures, wherein:

FIGS. 1A and 1B are each a side view an embodiment of the sleeves of the invention, showing the attachment of the dental floss to the sleeves;

FIGS. 1C through 1F show various surface patterns for providing high surface friction for ensuring retention and control of the floss;

FIGS. 2A and 2B each show a side view of a sleeve rolled up according to a preferred embodiment, and further depict how a rolled up sleeve is placed onto the tip of a finger in preparation for unrolling the sleeve onto the finger,

FIGS. 3A and 3B each show a side view of a sleeve that contains at least one textured surface used in a preferred embodiment for the purpose of cleaning areas of within the mouth not cleaned by dental floss; and

FIG. 4 is a view illustrating a method of using the invention to hold dental floss while inserting it between teeth.

### DETAILED DESCRIPTION

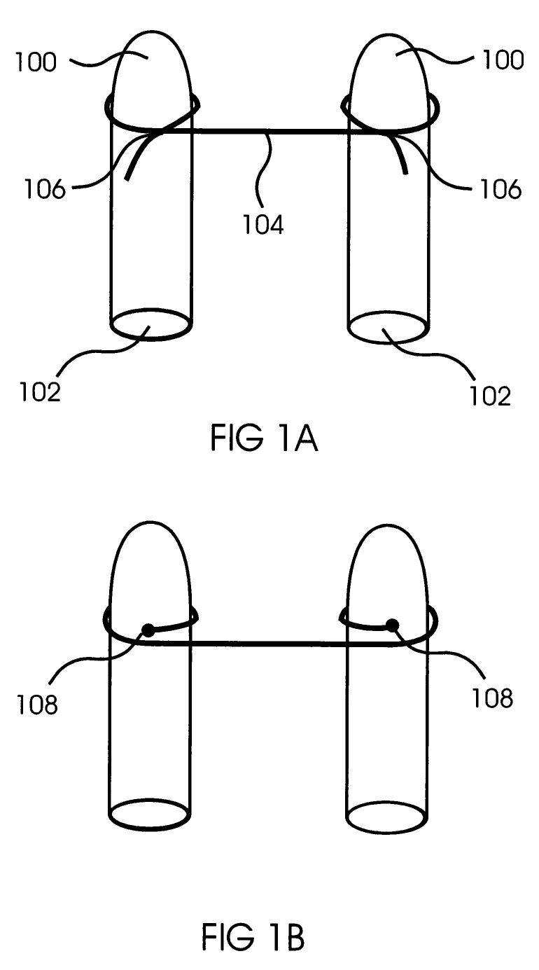

With reference to FIG. 1A, the apparatus of the invention consists of a pair of elastic sleeves 100, at least one end of each sleeve being open 102 so as to allow insertion of a finger by the user into each sleeve. A length of dental floss 104 with a first end and a second end is attached to the sleeves, the first end of the dental floss being wrapped at least once around the first sleeve, while the second end of the dental floss is wrapped at least once around the second sleeve. FIG. 1A illustrates a preferred embodiment wherein the ends of the dental floss are temporarily attached to the sleeves by wrapping the ends of the floss around the sleeves such that in each case the end of the dental floss is overlapped 106 by the floss that is wrapped around the sleeve. FIG. 1B illustrates a preferred embodiment wherein the ends of the floss are permanently attached to the sleeves by glue 108. The sleeves are constructed with a thickness sufficient to prevent tightly wrapped dental floss from causing discomfort or interfering with circulation, and with sufficient elastic tension and friction against the skin to cause them to be held firmly in place on the fingers while worn.

FIGS. 1C through 1F illustrate embodiments wherein each of at least some portion of the outer surface of the first and second sleeves bears grooves and/or bumps of sufficient depth and size to inhibit the dental floss from shifting its position when wrapped tightly around the grooved or bumped portion of a sleeve, and then subjected to forces sufficient to push the floss between teeth.

In FIG. 1C plurality of diagonal grooves is used. In FIG. 1D a plurality of crossed diagonal grooves is used. In FIG. 1E a combination of crossed diagonal grooves and horizontal grooves is used. In FIG. 1F, the pattern of FIG. 1E is combined with bumps that in a preferred embodiment also provide a suitable texture for massaging and cleaning tooth and gum surfaces. It will be clear to one skilled in the art that other patterns can be used to achieve substantially the same effect as the patterns of FIGS. 1C-1F.

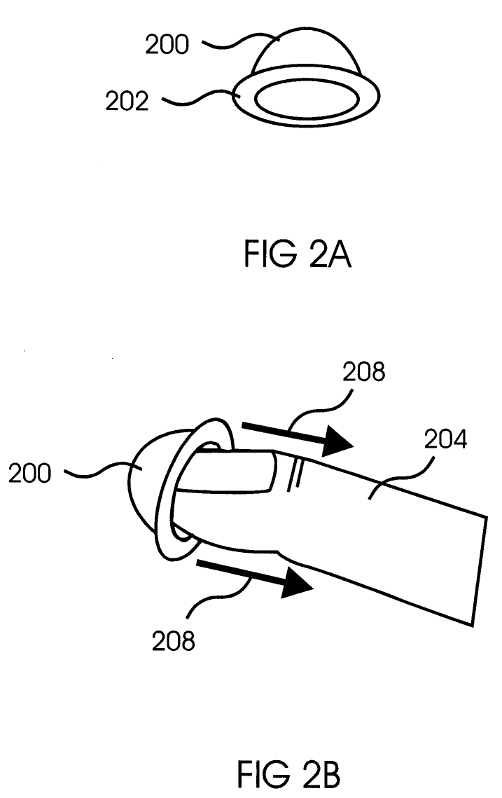

FIG. 2A shows a side view of a sleeve in a preferred embodiment wherein the sleeves 200 are manufactured of a material, and with a thickness, that allows them to be rolled up while not in use. When the sleeves 200 are rolled up, the surfaces 202 of the sleeves are protected from exposure to contaminants. The sleeves 200 are also more easily packaged and stored when they are in a rolled-up state.

FIG. 2B further illustrates how a rolled-up sleeve can be installed onto a finger 204 by first placing the rolled-up sleeve against the tip of the finger, and then unrolling it onto the finger in the direction indicated by the arrows 206, thereby eliminating the need for the inner surface of the sleeve to slide over the outer surface of the finger. In a similar manner, the sleeve can be removed by unrolling it from the finger.

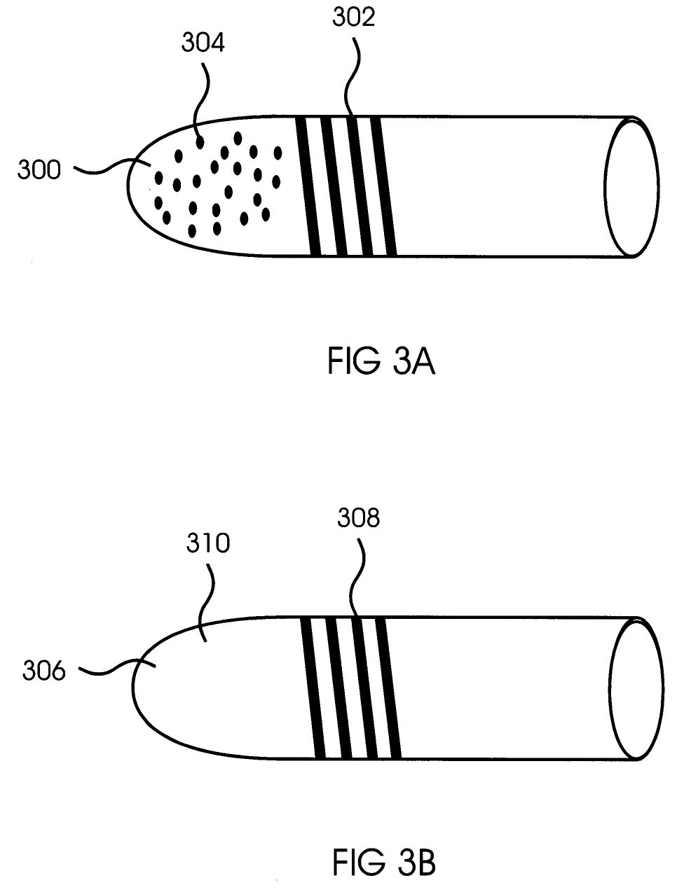

FIGS. 3A and 3B respectively illustrate embodiments wherein a sleeve can be used to clean tooth surfaces, and to massage gums and other tissue surfaces within the mouth. FIG. 3A shows a side view of a sleeve 300 wherein a portion of the outer surface contains grooves 302 as described above for the purpose of inhibiting movement of the dental floss while in use, and wherein a different portion of the sleeve 304 has appropriate texture and stiffness to be rubbed against and thereby to clean tooth surfaces and/or clean and stimulate gums and other regions of the mouth that are not cleaned by dental floss. In a combined embodiment of FIGS. 3A and 3B, the two sleeves of the invention are configured such that the first sleeve includes a region with appropriate texture and stiffness for cleaning and stimulating gums and other tissue regions within the mouth, and the second sleeve includes a smooth region which can be used to gently massage the gums. In this embodiment, the two sleeves are used together while flossing, the first sleeve is used separately to clean the gums and other tissue surfaces within the mouth, and the second sleeve is used to gently massage more sensitive areas of the mouth.

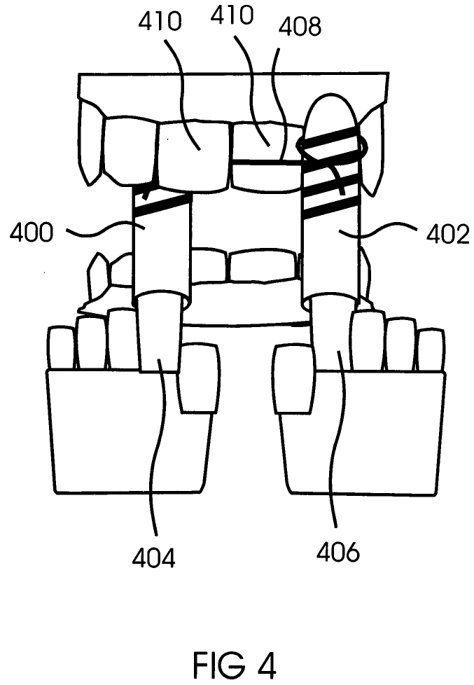

FIG. 4 illustrates the method of using the invention to hold dental floss and insert it between teeth. A first sleeve 400 and a second sleeve 402 are provided as described above. The first sleeve 400 is placed over a first finger 404 of the user, and the second sleeve 402 is placed over a second finger 406 of the user. In FIG. 4, the sleeves are worn on the two index fingers of the user, but other combinations of fingers may be selected depending on individual preference. A length of dental floss 408 is provided, and one end is attached to the first sleeve 400 and wrapped at least one full turn around the sleeve. The other end of the length of dental floss is attached to the second sleeve 402 and wrapped around the second sleeve in the same manner, and the length of floss is suspended between the two sleeves by spreading the fingers apart from each other until the length of floss is pulled tight between them. Then, the two fingers covered by the two sleeves are inserted into the mouth, such that the first sleeve 400 is positioned interior to the teeth and the second sleeve 402 is positioned exterior to the teeth, in such a manner that the length of floss tensioned between the two sleeves passes between two of the teeth 410. The two sleeves are then moved back and forth in various directions while maintaining tension on the dental floss, thereby causing the floss to rub along the tooth surfaces and gum margins between the teeth, cleaning them and removing any particles that have lodged there.

In preferred embodiments, as additional steps of the method, at least one of the sleeves is provided with texturing and a degree of stiffness appropriate for cleaning tooth surfaces and/or appropriate for cleaning and stimulating gums and/or other tissue surfaces within the mouth. The at least one sleeve is worn on a finger of the user, and the user inserts the at least one sleeve into his mouth, rubbing it against tooth and/or gums (and other tissue surfaces as appropriate), thereby cleaning surfaces that are not otherwise cleaned by dental floss.

Other modifications and implementations will occur to those skilled in the art without departing from the spirit and the scope of the invention as claimed. Accordingly, the above description is not intended to limit the invention except as indicated in the following claims.

What is claimed is:

1. Apparatus for enhanced dental flossing, the apparatus comprising:
a pair of elastomeric sleeves, each sized so as to be in a expanded condition when worn on a finger, each sleeve having an inner surface capable of substantially resisting slippage of the sleeve on the finger, and having an outer surface capable of substantially resisting slippage of the dental floss across the outer surface of the sleeve.

2. The apparatus of claim 1, wherein each elastomeric sleeve of the pair is made from latex.

3. The apparatus of claim 1, wherein each elastomeric sleeve of the pair is made of an elastomeric material that is of a thickness such that each finger is substantially protected from discomfort, even when the floss is wrapped tightly around each elastomeric sleeve, and then pulled between teeth.

4. The apparatus of claim 1, further including:
a length of dental floss having a first end and a second end, the first end being glued to the first elastomeric sleeve, and the second end being glued to the second elastomeric sleeve.

5. The apparatus of claim 1, wherein each elastomeric sleeve includes a portion bearing surface texturing capable of more surely gripping the floss than a smooth portion of the elastomeric sleeve.

6. The apparatus of claim 5, wherein the portion bearing surface texturing includes a surface bearing grooves capable of impeding slippage of dental floss over the surface when the floss is under tension during use.

7. The apparatus of claim 5, wherein the portion bearing surface texturing includes a surface bearing bumps capable of impeding slippage of dental floss over the surface when the floss is under tension during use.

8. The apparatus of claim 1, wherein the pair of elastomeric sleeves are stored in a rolled-up condition, such that they each can be placed on the tip of a finger, and then rolled down upon the finger for use.

9. The apparatus of claim 1, wherein the pair of elastomeric sleeves each includes a curled end for assisting in removing each sleeve by unrolling it from the finger.

10. The apparatus of claim 1, wherein the pair of sleeves is disposable.

11. The apparatus of claim 1, wherein at least a portion of the outer surface of at least one sleeve bears a texture capable of cleaning and stimulating at least gums within the mouth.

12. The apparatus of claim 1, wherein at least a portion of the outer surface of at least one sleeve bears a surface that is capable of gently massaging sensitive tissue in a mouth.

13. A method for using dental floss, the method comprising:
rolling a first elastomeric sleeve onto a first finger;
rolling a second elastomeric sleeve onto a second finger;
wrapping a first end of a length of dental floss at least one full turn around the first elastomeric sleeve;
wrapping the second end of the length of dental floss at least one full turn around the second elastomeric sleeve;
applying tension to the length of dental floss so as to cause the first end of the length of dental floss to be held tightly in place around the first elastomeric sleeve, and the second end to be held tightly in place around the second elastomeric sleeve; and
repeatedly passing the dental floss between and over a surface of teeth in a mouth.

14. The method of claim 13, further including:
stimulating gums using at least a portion of at least one sleeve bearing a texture capable of gum stimulation.

15. Apparatus for enhanced dental flossing, the apparatus comprising:
a pair of elastomeric sleeves,
each sleeve sized so as to be in a expanded condition when worn on a finger,
each sleeve having an inner surface capable of substantially resisting slippage of the sleeve on the finger,
each sleeve having an outer surface capable of substantially resisting slippage of the dental floss across the outer surface of the sleeve,
each sleeve being make from a material of a thickness such that each finger is substantially protected from discomfort, even when the floss is wrapped tightly around each sleeve, and then pulled between teeth,
each sleeve including a portion bearing surface texturing capable of more surely gripping the floss than a smooth portion of the sleeve; and
a length of dental floss having a first end and a second end, the first end being glued to the first sleeve, and the second end being glued to the second sleeve.

16. The apparatus of claim 15, wherein each elastomeric sleeve is made from latex.

17. The apparatus of claim 15, wherein the portion bearing surface texturing includes a surface bearing grooves capable of impeding slippage of dental floss over the surface when the floss is under tension during use.

18. The apparatus of claim 15, wherein the portion bearing surface texturing includes a surface bearing bumps capable of impeding slippage of dental floss over the surface when the floss is under tension during use.

19. The apparatus of claim 15, wherein the pair of sleeves are stored in a rolled-up condition, such that they each can be placed on the tip of a finger, and then rolled down upon the finger for use.

20. The apparatus of claim 15, wherein at least a portion of the outer surface of at least one sleeve bears a texture capable of cleaning and stimulating at least gums within the mouth.
